(19) United States
(12) Patent Application Publication
(10) Pub. No.: US 2015/0316937 A1
(43) Pub. Date: Nov. 5, 2015

(54) GAS PRESSURE CONTROLLER

(71) Applicant: SHIMADZU CORPORATION, Kyoto-shi, Kyoto (JP)

(72) Inventors: Minoru KASHIHARA, Kyoto-shi (JP); Kazunori TAKAHASHI, Kyoto-shi (JP); Jun YANAGIBAYASHI, Kyoto-shi (JP); Takahiro NISHIMOTO, Kyoto-shi (JP)

(73) Assignee: SHIMADZU CORPORATION, Kyoto-shi, Kyoto (JP)

(21) Appl. No.: 14/761,972

(22) PCT Filed: Jan. 28, 2013
(86) PCT No.: PCT/JP2013/051774

§ 371 Date: Jul. 20, 2015

(51) Int. Cl. G05D 16/20; F16K 31/04

(52) U.S. Cl. CPC G05D 16/2013; F16K 31/04

(57) ABSTRACT

A pressure controller is provided with an insulating substrate having a gas inlet and a gas outlet and including an inner channel, a valve mechanism including an MEMS valve element that is attached directly to a front surface or a back surface of the insulating substrate and that is connected to the inner channel via a port communicating with the inner channel, a pressure sensor section including an MEMS pressure sensor element that is attached directly to the front surface or the back surface of the insulating substrate and that is connected to the inner channel via a port communicating with the inner channel, and a control section for feedback-controlling the valve mechanism based on a detection signal of the pressure sensor section.

### TECHNICAL FIELD

The present invention relates to a gas pressure controller that is used, for example, on an analysis device such as a gas chromatograph, to control the flow rate of carrier gas or to control the flow rate of gas to be supplied to a detector.

### BACKGROUND ART

In the analysis by a gas chromatograph, it is necessary to maintain a constant flow rate of carrier gas for carrying a sample to a separation column or a constant flow rate of gas to be supplied to a detector. To this end, a gas pressure controller is provided at a position where depressurized gas is supplied to the gas chromatograph from a gas cylinder, and a pressure valve for adjusting the pressure of gas supplied from the gas cylinder and a pressure sensor for detecting the pressure in a channel on the outlet side of the pressure valve are attached to the gas pressure controller, and the pressure valve is controlled based on the pressure detected by the pressure sensor so that the pressure becomes constant.

Generally, the pressure valve and the pressure sensor are attached to a common metal channel substrate (see Patent Documents 1 and 2). The channel substrate is a substrate possessing a channel inside, and is formed by stacking metal flat plates, and a port for connecting a cylinder for supplying gas and a port for connecting to the gas chromatograph are provided to the channel substrate, in addition to ports for connecting the inlets and outlets of the pressure sensor and the pressure valve.

### PRIOR ART DOCUMENTS

### Patent Documents

Patent Document 1: Japanese Patent Laid-open Publication No. 10-026300

Patent Document 2: Japanese Patent Laid-open Publication No. 11-218528

### SUMMARY OF THE INVENTION

### Problems to be Solved by the Invention

There is a demand for miniaturization of a gas pressure controller which has a pressure valve and a pressure sensor mounted on a channel substrate. As a method of miniaturizing the gas pressure controller, it is conceivable to use, as the pressure valve and the pressure sensor, elements formed by MEMS (micro-electro-mechanical system) technology, for example. An element formed by the MEMS technology (hereinafter referred to as an MEMS element) is generally formed by micro-processing a silicon substrate. Thus, if an MEMS element is mounted on a metal channel substrate, since the difference between the linear expansion coefficients between the silicon forming the MEMS element and the metal of the channel substrate is great, there is a problem that stress is applied to the MEMS element due to temperature change, and the performance of the MEMS element is reduced.

Accordingly, the present invention has its aim to suppress reduction in the performance of an MEMS element caused by temperature change even in a case where an MEMS element is used to achieve a small gas pressure controller.

### Solutions to the Problems

A gas pressure controller of the present invention includes an insulating substrate having a gas inlet and a gas outlet, and including an inner channel, a valve mechanism including an MEMS valve element that is attached directly on a front surface or a back surface of the insulating substrate and that is connected to the inner channel via a port communicating with the inner channel, a pressure sensor section including an MEMS pressure sensor element that is attached directly on the front surface or the back surface of the insulating substrate and that is connected to the inner channel via a port communicating with the inner channel, and a control section for feedback-controlling the valve mechanism based on a detection signal of the pressure sensor section.

One mode of the insulating substrate is a stacked body formed from a plurality of insulating substrate layers. With a stacked body, the inner channel may easily be formed.

A metal layer for electromagnetic shielding, not contributing to electrical connection, is desirably formed on at least one of the front surface, the back surface, and an inner joining surface of the insulating substrate. The inner joining surface is present in the case where the insulating substrate is a stacked body formed from a plurality of insulating substrate layers. By providing the metal layer for electromagnetic shielding, an external noise may be absorbed.

An example of the insulating substrate is alumina ceramic. The alumina ceramic has good thermal conductivity, and is convenient in making the temperature of the entire substrate uniform.

The inner channel desirably includes a channel resistor portion whose channel width is narrower than a channel communicating with the gas outlet. In the case of providing a channel resistor for adjusting the flow rate, an external channel resistor would increase the size to the extent of the channel resistor and a connector for connecting the same to the inner channel, and there is also a possibility of gas leakage from the connector. In contrast, if the channel resistor portion is provided to the inner channel, such inconveniences are not caused.

Some MEMS valve elements need an actuator as a driving source. Although not particularly limited, a piezo actuator or a solenoid actuator may be used as such an actuator. Moreover, some MEMS valve elements do not need a driving source. As such an MEMS valve element, there is an MEMS valve element that is driven by electrostatic force. Either MEMS valve element may be used for the present invention.

The MEMS pressure sensor element to be used for the present invention is not particularly limited, and, for example, a capacitive pressure sensor element or a piezoresistive pressure sensor element may be used. In the case of a capacitive pressure sensor element, the pressure sensor section includes a capacitance-to-digital converter for converting a detected capacitance to a voltage output. Since a piezoresistive pressure sensor element generates a voltage output, a converter is not necessary unlike in the case of the capacitive pressure sensor element.

The control section desirably includes a temperature correction section for correcting a variation in a detection output of the MEMS pressure sensor element due to a temperature. A temperature sensor is necessary for temperature correction, but in the case where the capacitance-to-digital converter includes a temperature measurement function, the temperature correction section may be configured to correct a variation in a detection output of the MEMS pressure sensor element due to a temperature, based on a signal corresponding to a temperature measured by the temperature measurement function of the capacitance-to-digital converter. The insulating substrate may be provided with a temperature measurement element, and in this case, the temperature correction section may be configured to correct a variation in a detection output of the MEMS pressure sensor element due to a temperature, based on a detection signal of the temperature measurement element.

### Effects of the Invention

According to the gas pressure controller of the present invention, an

MEMS valve element and an MEMS pressure sensor element are attached directly on an insulating substrate including an inner channel, and thus, the difference between the linear expansion coefficients of the substrate and the valve element is small, and also the difference between the linear expansion coefficients of the substrate and the pressure sensor element is small, and thus, the stress that is applied on the valve element and the pressure sensor element due to a temperature change is reduced and influence of the environmental temperature is reduced. As a result, reduction in the performance of the valve element and the pressure sensor element may be suppressed.

Examples of the linear expansion coefficient are as follows:

silicon: 2×10⁻⁶/° C.,

alumina ceramic: 7×10⁻⁶/° C.,

stainless steel: 10 to 17×10⁻⁶/° C.

The alumina ceramic is a representative example of the insulating substrate, and it can be seen that, compared with the stainless steel as a representative metal, its linear expansion coefficient is closer to that of silicon.

### BRIEF DESCRIPTION OF THE DRAWINGS

FIG. 1 is a perspective view schematically showing main sections of an embodiment.

FIG. 2 is a plan view showing the front surface side of each substrate layer of the embodiment.

FIG. 3 is a plan view showing the front surface side of each substrate layer of another embodiment.

FIG. 4A is a perspective view showing further another embodiment.

FIG. 4B is a cross-sectional view at the position A-A in FIG. 4A.

FIG. 5A is a plan view showing the front surface side of a substrate layer at the first layer of the embodiment.

FIG. 5B is a plan view showing the front surface side of a substrate layer at the second layer of the embodiment.

FIG. 5C is a plan view showing the front surface side of a substrate layer at the third layer of the embodiment.

FIG. 5D is a plan view showing the front surface side of a substrate layer at the fourth layer of the embodiment. FIG. 5E is a plan view showing the front surface side of a substrate layer at the fifth layer of the embodiment.

FIG. 5F is a plan view showing the front surface side of a substrate layer at the sixth layer of the embodiment.

FIG. 5G is a plan view showing the back surface side of the substrate layer at the sixth layer of the embodiment.

FIG. 6 is a cross-sectional view showing a valve element of the embodiment.

FIG. 7 is a cross-sectional view showing a pressure sensor element of the embodiment.

FIG. 8 is a block diagram showing a feedback system for gas pressure control that is common to the embodiments.

FIG. 9 is a graph showing an example of temperature correction for detection output of a capacitive pressure sensor element.

### EMBODIMENTS OF THE INVENTION

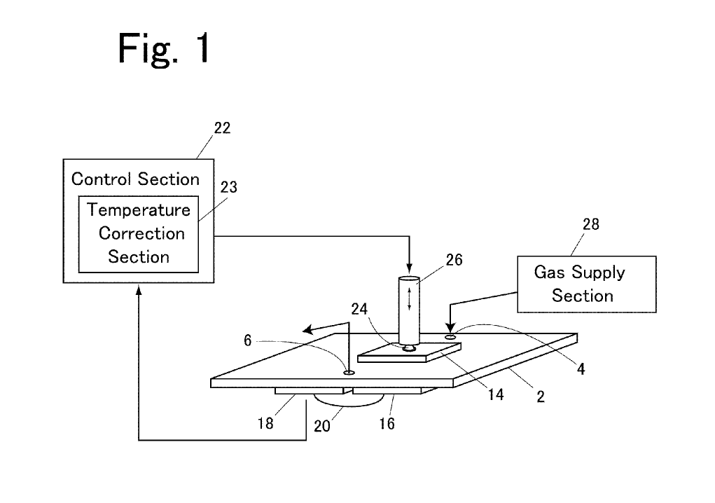

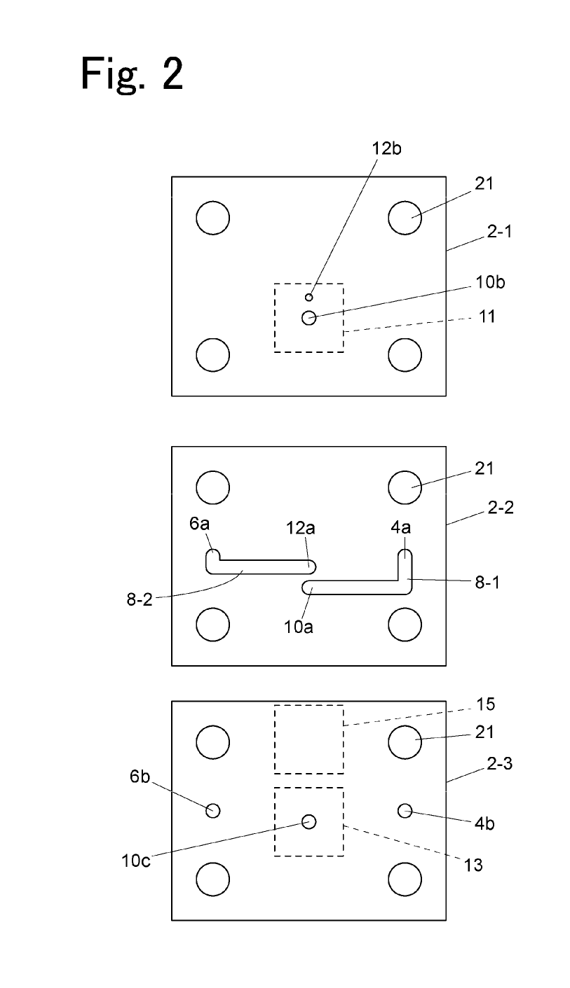

A gas pressure controller of an embodiment is schematically shown in FIGS. 1 and 2. An insulating substrate 2 includes an inner channel, and a gas inlet 4 and a gas outlet 6 communicating with the inner channel are formed to one surface of the substrate 2. The insulating substrate 2 is an alumina ceramic substrate in this case, but it may alternatively be a substrate made of another insulating material such as a resin that is used for a multi-layer wiring substrate, such as polyimide, glass or the like.

Since the substrate 2 includes an inner channel, it is desirably a stacked body formed from a plurality of insulating substrate layers. As shown in FIG. 2, in this embodiment, it is formed from alumina ceramic substrate layers 2-1 to 2-3 having thicknesses of about 0.1 to 0.5 mm. The substrate layer 2-3 as the lowermost layer, the substrate layer 2-2 as the intermediate layer, and the substrate layer 2-1 as the uppermost layer are stacked, sintered and integrated. Although not shown in FIGS. 1 and 2, a metal layer is formed on at least one of the front surface, the back surface and the inside of the substrate 2. Other than being a metal wiring layer for electrical connection, the metal layer may be a metal layer for noise removal, a metal layer for fixing parts such as a connector by solders, or the like.

Referring to FIG. 2, penetrating grooves 8-1 and 8-2 to be inner channels are formed on the intermediate substrate layer 2-2 to form the inner channels. The groove 8-1 is to be a channel on the inlet side, and its one end 4a is arranged on the peripheral side of the substrate, and its other end 10a is arranged on the center side of the substrate. The groove 8-2 is to be a channel on the outlet side, and its one end 6a is arranged on the peripheral side of the substrate, and its other end 12a is arranged on the center side of the substrate. The other end 10a of the groove 8-1 and the other end 12a of the groove 8-2 are arranged at positions corresponding to the inlet and the outlet of an MEMS valve element to be mounted on the substrate 2. The grooves 8-1 and 8-2 have a width of about 1 mm.

A penetration hole 4b to be the gas inlet 4 is formed on the lower substrate layer 2-3, at a position corresponding to the one end 4a of the groove 8-1, and a penetration hole 6b to be the gas outlet 6 is formed at a position corresponding to the one end 6a of the groove 8-2.

A penetration hole 10b to be a valve inlet hole is formed on the upper substrate layer 2-1, at a position corresponding to the other end 10a of the groove 8-1, and a penetration hole 12b to be a valve outlet hole is formed at a position corresponding to the other end 12a of the groove 8-2. A region 11, shown by a dashed line, surrounding the penetration holes 10b and 12b is a valve element mounting position, and as shown in FIG. 1, an MEMS valve element 14 is mounted in the region 11, on the front surface side of the substrate 2, by being fixed by an adhesive.

Furthermore, a penetration hole 10c to be a pressure sensor inlet hole is formed on the lower substrate layer 2-3, at a position corresponding to the other end 12a of the groove 8-2. A region 13, shown by a dashed line, surrounding the penetration hole 10c is a pressure sensor element mounting position, and as shown in FIG. 1, an MEMS pressure sensor element 16 is mounted in the region 13, on the back surface side of the substrate 2, by being fixed by an adhesive.

By directly attaching the valve element 14 and the pressure sensor element 16 to the substrate 2 and joining them to the channels inside the substrate 2 in this manner, piping of a gas pipe for connection between the valve element 14 and the pressure sensor element 16 is made unnecessary and miniaturization may be achieved.

A region 15, shown by a dashed line, arranged near the region 13 on the lower substrate layer 2-3 is a capacitance-to-digital converter mounting position. A capacitance-to-digital converter becomes necessary in the case where the pressure sensor element 16 is of a capacitive type. In this example, a capacitive pressure sensor element is used, and thus, a capacitance-to-digital converter 18 is mounted in the region 15, on the back surface side of the substrate 2, as shown in FIG. 1. A metal wiring layer (not shown) is formed on the back surface of the substrate 2, and the capacitance-to-digital converter 18 is mounted on the metal wiring layer by a solder material through electrical connection and mechanical joining. The pressure sensor element 16 and the capacitance-to-digital converter 18 are connected by wire bonding 20.

The wire for the wire bonding is made shorter as the pressure sensor element 16 and the capacitance-to-digital converter 18 are arranged closer to each other, and the parasitic capacitance may be made smaller to that degree and the noise may be reduced.

A via hole or a through hole for connecting a metal wiring layer for connecting other electronic parts or between layers is also formed as necessary to at least one of the substrate layers 2-1 to 2-3, other than the metal wiring layer for connecting to the capacitance-to-digital converter 18. An electronic part accompanying the capacitance-to-digital converter 18 is also mounted on the metal wiring layer of the substrate 2 by a solder material through electrical connection and mechanical joining. Furthermore, a metal layer for electromagnetic shielding, not contributing to electrical connection, is formed on at least one of the substrate layers 2-1 to 2-3. This metal layer is connected to the ground, and is used for noise reduction.

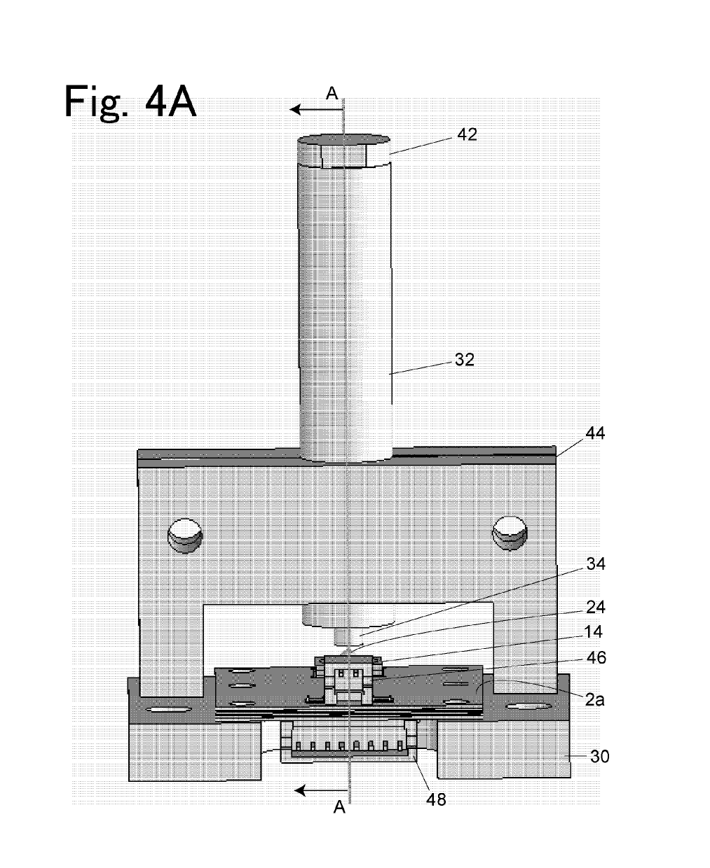

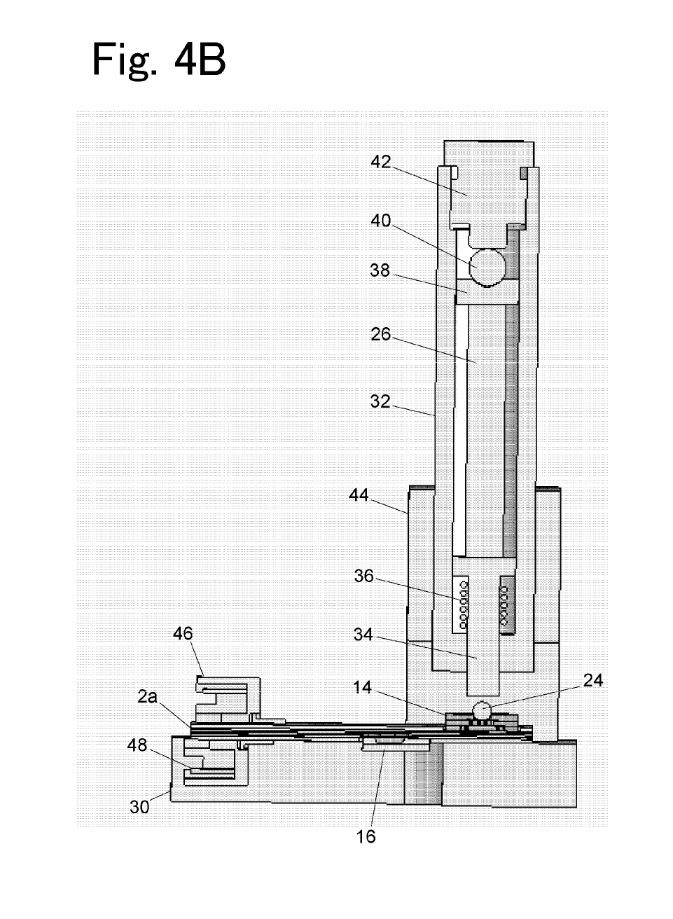

Penetration holes 21 formed in four corners of each substrate layer in FIG. 2 are holes for fixing the insulating substrate 2 to a fixing base by screws. The fixing base is omitted from FIG. 1, but is something like a fixing base 30 shown in the embodiment in, for example, FIGS. 4A and 4B.

An actuator 26 is arranged above the valve element 14 via a ball 24, for driving the valve element 14. The actuator 26 is a piezo actuator or a solenoid actuator. A control section 22 for driving the valve element 14 through the actuator 26 based on a detection signal of a pressure sensor section including the pressure sensor element 16 is provided. The control section 22 feedback-controls the valve element 14 through the actuator 26 in such a way that a detection signal of the pressure sensor element 16 will take a predetermined value.

An MEMS valve element that is driven by electrostatic force may also be used as the valve element 14. In the case of an MEMS valve element that is driven by electrostatic force, electrostatic attraction that is caused by applying a voltage between two electrodes provided in one element is taken as the driving force, and thus, the actuator 26 outside the element becomes unnecessary.

The pressure sensor element 16 may be either of a capacitive type and a piezoresistive type. As in this embodiment, in the case of a capacitive type, the detection output is capacitance, and the capacitance-to-digital converter 18 for converting the capacitance to a voltage is necessary, but in the case of a piezoresistive type, the output is a voltage, and the capacitance-to-digital converter 18 is not necessary.

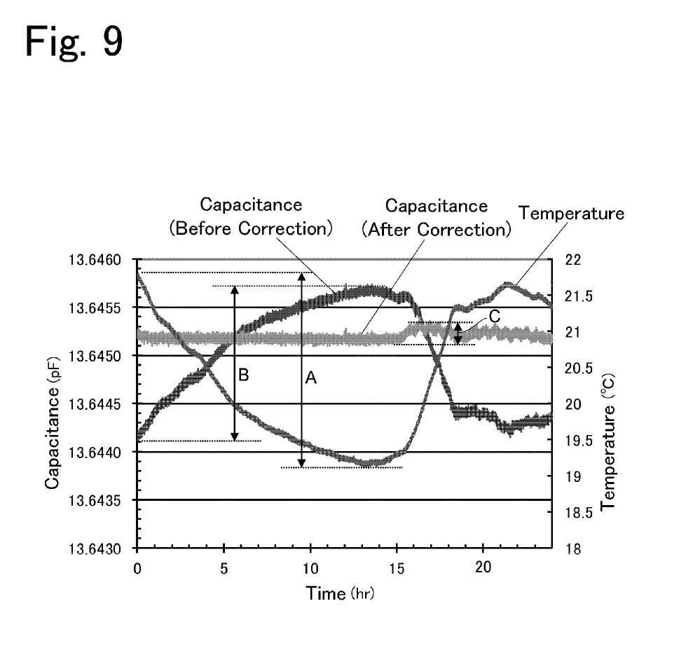

The control section 22 is provided with a temperature correction section 23. In the case where the pressure sensor element 16 is of a capacitive type, a detected capacitance value has temperature dependence, and thus, the temperature correction section 23 includes a function of suppressing a variation in the capacitance value caused by a variation in the environmental temperature, as shown later with reference to FIG. 9.

To correct a variation in the capacitive value due to temperature, the environmental temperature around the sensor element has to be detected. A temperature sensor may be provided in contact with the substrate 2 for this purpose. In the case where alumina ceramic is used for the substrate 2, since alumina ceramic has good thermal conductivity and the temperature of the substrate 2 is uniform regardless of the position, the position for arranging the temperature sensor is not particularly limited. In the case of using a substrate 2 with poor thermal conductivity, the temperature sensor is desirably arranged near the pressure sensor element 16.

In the case where the capacitance-to-digital converter 18 is provided, since the capacitance-to-digital converter 18 generally includes a temperature measurement function, the temperature measurement function may be used as the temperature sensor to thereby omit the temperature sensor.

In the case where the pressure sensor element 16 is of a piezoresistive type of a semiconductor material, since a change in the piezoresistance is affected by a change in the carrier concentration and the carrier concentration is dependent on temperature, the piezoresistance value has temperature dependence, and it is desirable to suppress a variation in the piezoresistance value caused by a variation in the environmental temperature by the temperature correction section 23 as in the case of the capacitive type. In the case of a piezoresistive pressure sensor element, a capacitance-to-digital converter is not mounted, and a temperature compensation circuit including a temperature sensor is mounted on the substrate 2.

The control section 22 is realized by a dedicated computer of a measurement appliance such as a gas chromatograph where the gas pressure controller is mounted, or by a general-purpose personal computer.

Although not shown, a connector for connecting with the control section 22 is mounted on the substrate 2.

Operation of the embodiment in FIG. 1 will be described. To supply gas from a gas supply section 28 such as a gas cylinder, a gas pipe is connected to the gas inlet 4 of the substrate 2 via a connector, and to guide the gas which has flowed through the internal channel to an analysis appliance such as a gas chromatograph, a gas pipe is connected to the gas outlet 6 via a connector.

Gas supplied from the gas supply section 28 reaches the gas outlet 6 through the gas inlet 4, the inlet-side inner channel 8-1 of the substrate 2, the valve element 14 and the outlet-side inner channel 8-2. At this time, the pressure in the inner channel 8-2 is detected by the pressure sensor element 16. The pressure of gas flowing through the inner channel is made constant by the valve element 14 being feedback-controlled via the actuator 26 based on an output signal of the capacitance-to-digital converter 18 to which an output signal of the pressure sensor element 16 has been input. The flow rate of gas flowing out from the gas outlet is made constant in this manner.

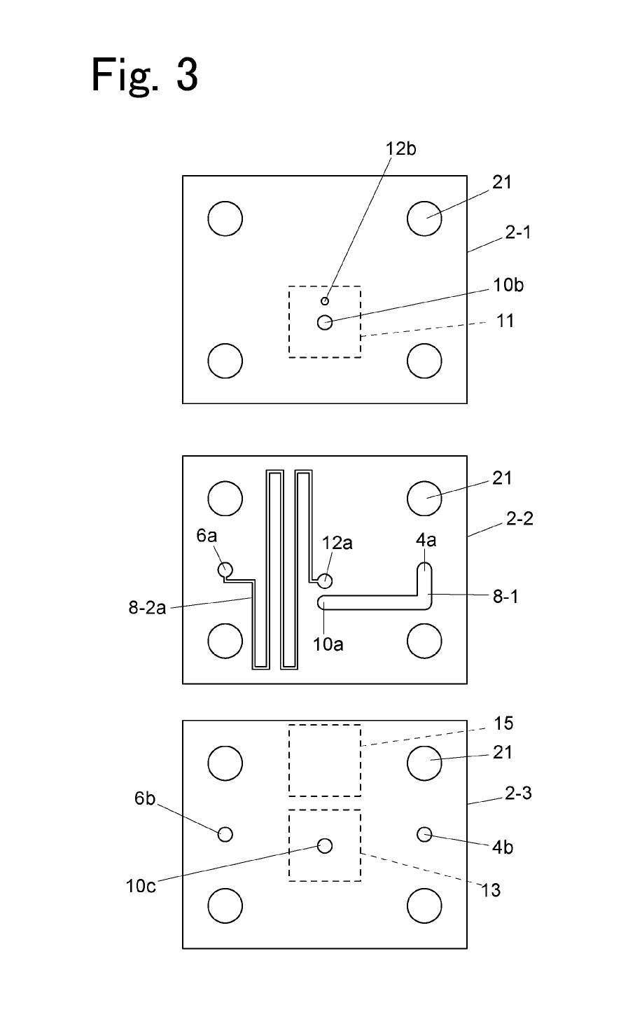

FIG. 3 shows a second embodiment. Compared with the second embodiment, an inner channel 8-2a formed on a substrate layer 2-2 at the second layer is different from the inner channel 8-2 in FIG. 2 in that the inner channel 8-2a has a narrower width and is made a channel resistor. The width of the channel 8-1 is about 1 mm, but the width of the channel 8-2a is set to be narrow according to a desired channel resistance, and is, for example, 0.1 to 0.5 mm. Holes 6a and 12a at both ends of the channel 8-2a have a diameter of about 1 mm. The channel resistor 8-2a is used for adjustment of flow rate.

In this manner, by providing the channel resistor 8-2a inside the substrate, an external channel resistor is made unnecessary, and miniaturization may be realized to that extent. Also, there is no possibility of gas leakage from a connector for connecting an external channel resistor.

Next, a third embodiment will be described in detail with reference to FIGS. 4A to 8.

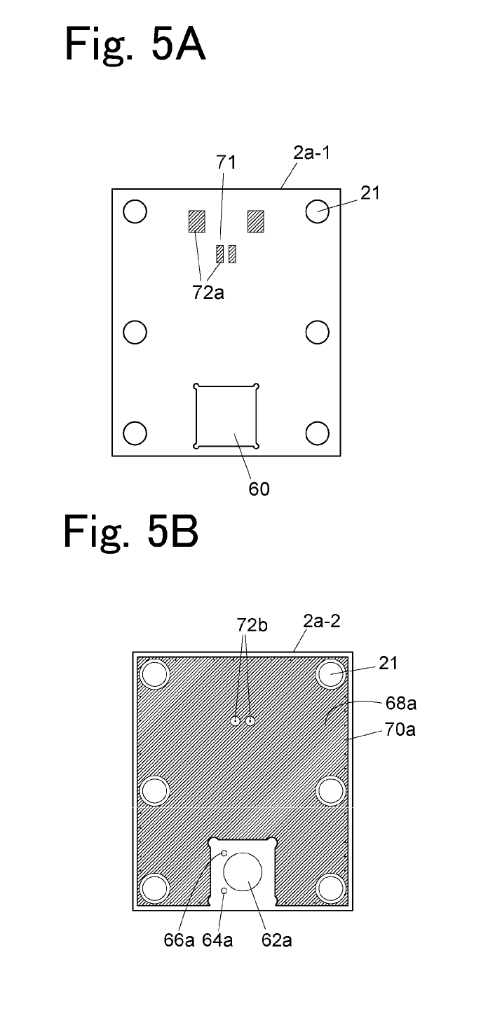

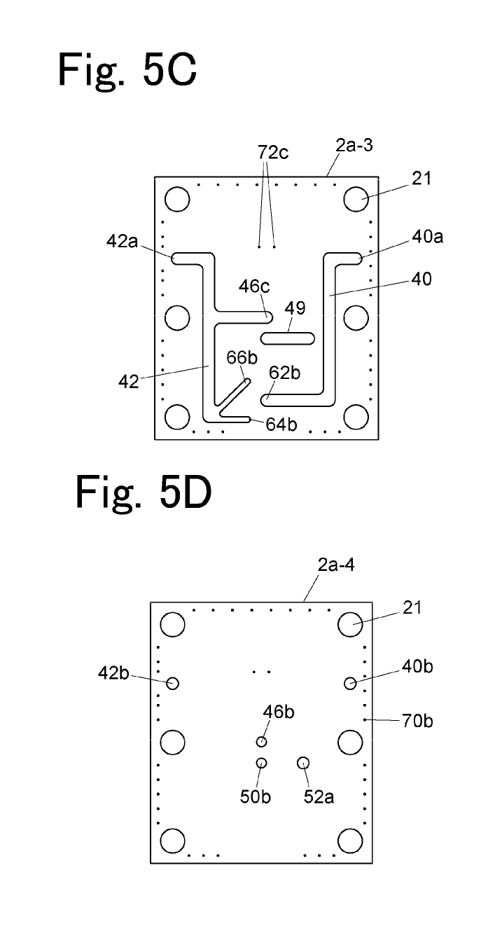

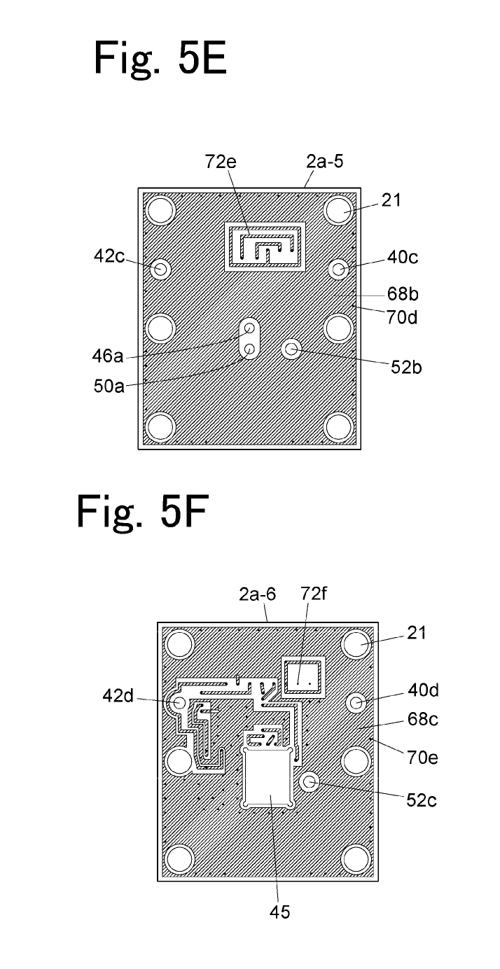

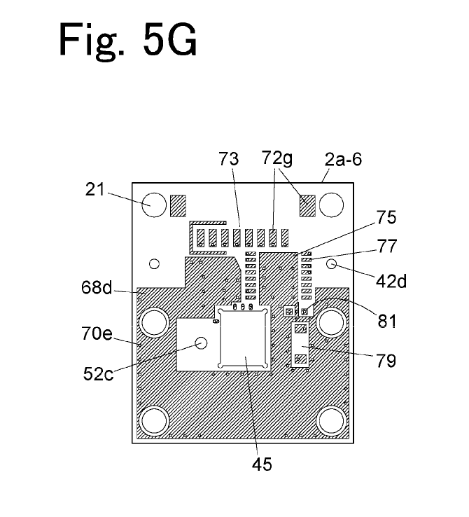

FIG. 4A is a perspective view of the entire appearance, and FIG. 4B is a cross-sectional view at the position A-A in FIG. 4A. An insulating substrate 2a is fixed to a metal fixing base 30 by screws through holes 21 (see FIG. 5A and the like). A MEMS pressure sensor element 16 is fixed to the back surface side of the substrate 2a by an adhesive. The pressure sensor element 16 is, for example, of a capacitive type. Although not shown in FIGS. 4A and 4B, a capacitance-to-digital converter is mounted on the back surface side of the substrate 2a, near the pressure sensor element 16, and the capacitance-to-digital converter is electrically connected and mechanically joined by a solder material to a metal wiring layer 77 (see FIG. 5G) that is formed on the back surface of the substrate 2a.

An MEMS valve element 14 is fixed to the front surface side of the substrate 2a by an adhesive. To drive the valve element 14, an actuator 26 is arranged above the valve element 14 via a ball 24 in such a way as to press down on the valve element 14 from above. The actuator 26 is, for example, a piezo actuator. The actuator 26 is housed in a case 32, and a pin 34 is arranged inside the case 32, below the actuator 26, and a coil spring 36 for biasing the pin 34 upward is housed between the pin 34 and the inner surface of the tip end portion of the case 32. The upper end of the actuator 26 is sealed by a cap 42 via a ball base 38 and a ball 40. The actuator 26 is thereby housed inside the case 32 while being pressed upward by the spring 36. The case 32 is fixed to the base 30 via a fixing frame 44.

When the actuator 26 is operated in the extending direction by application of a voltage, the pin 34 extends downward from the case 32 and causes the valve 14 to operate via the ball 24.

Connectors 46 and 48 are mounted on the substrate 2a, on the front surface side and the back surface side, respectively, and the connectors 46 and 48 are electrically connected and mechanically joined, respectively, to metal wiring layers 72a and 72g (see FIGS. 5A and 5G) on the front surface side and the back surface side of the substrate 2a by solder materials. The connector 46 is for applying a voltage on the piezo actuator, and the connector 48 is for externally outputting a signal of the capacitance-to-digital converter and for controlling the piezo actuator. The pressure sensor element 16 and the capacitance-to-digital converter are connected by wire bonding. The capacitance-to-digital converter and the connector 48 are connected by metal wiring layers formed on the front surface, the back surface and on the inside of the substrate 2a and metal layers 72a to 72g at through holes (see FIGS. 5A to 5G).

FIGS. 5A to 5G show respective layers of the substrate 2a in detail. The substrate 2a has six insulating substrate layers 2a-1 to 2a-6 stacked, sintered and joined together. Each of the substrate layers 2a-1 to 2a-6 is an alumina ceramic substrate having a thickness of about 0.1 to 0.5 mm. The substrate layers 2a-1 to 2a-6 are referred to as the first layer, the second layer, and the like from the uppermost layer. FIGS. 5A to 5F show the upper surface side of the respective substrate layers 2a-1 to 2a-6, and FIG. 5G shows the back surface side of the substrate layer 2a-6 on the sixth layer. The substrate layer 2a-6 on the sixth layer is made the lowermost layer, and then substrate layers are stacked on this layer in the order of the substrate layer 2a-5 at the fifth layer, the substrate layer 2a-4 on the fourth layer and so on, with the substrate layer 2a-1 on the first layer as the uppermost layer, and are sintered.

Inlet-side channel 40, an outlet-side channel 42, and an atmosphere-side communicating channel 49 of the pressure sensor are formed on the substrate layer 2a-3 at the third layer by penetration grooves as inner channels. One end 40a of the inlet-side channel 40 overlaps a penetration hole 40b of the substrate layer 2a-4 on the fourth layer, a penetration hole 40c of the substrate layer 2a-5 on the fifth layer, and a penetration hole 40d of the substrate layer 2a-6 on the sixth layer to form a gas inlet hole. One end 42a of the outlet-side channel 42 overlaps a penetration hole 42b of the substrate layer 2a-4 on the fourth layer, a penetration hole 42c of the substrate layer 2a-5 on the fifth layer, and a penetration hole 42d of the substrate layer 2a-6 on the sixth layer to form a gas outlet hole.

A rectangular penetration hole 45 for mounting the pressure sensor element 16 is opened to the substrate layer 2a-6 on the sixth layer shown in FIG. 5G, and the pressure sensor element 16 is mounted by being fitted therein. To connect the pressure sensor element 16 and the inner channel, a penetration hole 46a is formed on the substrate layer 2a-5 of the fifth layer, at a position corresponding to the opening position on the detection side of the pressure sensor element 16, and a penetration hole 46b is formed on the substrate layer 2a-4 on the fourth layer, and these holes 46a and 46b overlap a portion 46c branched from the outlet-side channel 42 of the substrate layer 2a-3 on the third layer.

In order for the pressure sensor element 16 to detect a pressure difference between the pressure in the inner channel 42 and the atmospheric pressure, a penetration hole 50a is formed on the substrate layer 2a-5 of the fifth layer, at a position corresponding to the opening on the atmosphere side of the pressure sensor element 16 and a penetration hole 50b is formed on the substrate layer 2a-4 at the fourth layer, and these holes 50a and 50b overlap one end of the atmosphere-side communicating path 49 of the substrate layer 2a-3 on the third layer. A penetration hole 52a, a penetration hole 52b, and a penetration hole 52c are formed on the substrate layer 2a-4 at the fourth layer, the substrate layer 2a-5 on the fifth layer, and the substrate layer 2a-6 on the sixth layer, respectively, at positions corresponding to the other end side of the atmosphere-side communicating path 49 of the substrate layer 2a-3 on the third layer, and these penetration holes overlap one another to form an air hole that is opened to air.

A rectangular penetration hole 60 is formed on the substrate layer 2a-1 at the first layer for mounting the valve element 14, and the valve element 14 is mounted by being fitted into the penetration hole 60. The substrate layer 2a-2 on the second layer has formed, at a valve mounting position, as penetration holes, a valve inlet hole 62a at a position corresponding to the inlet of the valve element 14, and valve outlet holes 64a and 66a at positions corresponding to the outlet of the valve element 14. Other end 62b of the inlet-side channel groove 40 of the substrate layer 2a-3 on the third layer is positioned so as to be on the inside of the valve inlet hole 62a of the substrate layer 2a-2 on the second layer, and other ends 64b and 66b of the outlet-side channel groove 42 of the substrate layer 2a-3 are positioned so as to overlap the valve outlet holes 64a and 66a, respectively, of the substrate layer 2a-2 on the second layer. The valve element 14 is thus arranged between the inlet-side channel groove 40 and the outlet-side channel groove 42.

This embodiment shows the valve element 14 with two outlets, but the valve element 14 may alternatively have one outlet.

Metal layers 68a, 68b, and 68c shown by hatching are formed on the upper surface of the substrate layers 2a-2, 2a-5, and 2a-6, respectively. The substrate layer 2a-6 has a metal layer 68d formed also on its lower surface. These metal layers are for blocking the external noise, and are electrically connected to one another via via holes or through holes 70a to 70e.

The position indicated by a reference sign 71 on the upper surface of the substrate layer 2a-1 on the first layer is the position for mounting the connector 46, and the position indicated by a reference sign 73 on the back surface of the substrate layer 2a-6 on the sixth layer is the position for mounting the connector 48. The connectors 46 and 48 are electrically connected to each other by a solder material via a via hole or a through hole and the metal layers 72a to 72g on the front surface, the back surface and on the inside of the substrate 2a, and are fixed to the substrate 2a.

Six penetration holes 21 are opened at the same positions to each of the substrate layers 2a-1 to 2a-6, and the substrate 2a is fixed to the fixing base 30 by screws through these holes 21. The number of the penetration holes 21 is not particularly limited.

The position indicated by a reference sign 75 on the back surface side of the substrate layer 2a-6 on the sixth layer is the position for mounting the capacitance-to-digital converter, and a metal layer 77 for electrically connecting and mechanically fixing the capacitance-to-digital converter by a solder material is formed at the position. The position indicated by a reference sign 79 is the position for mounting a capacitor to be used by the capacitance-to-digital converter, and the position indicated by a reference sign 81 is the position for mounting a resistor to be used by the capacitance-to-digital converter.

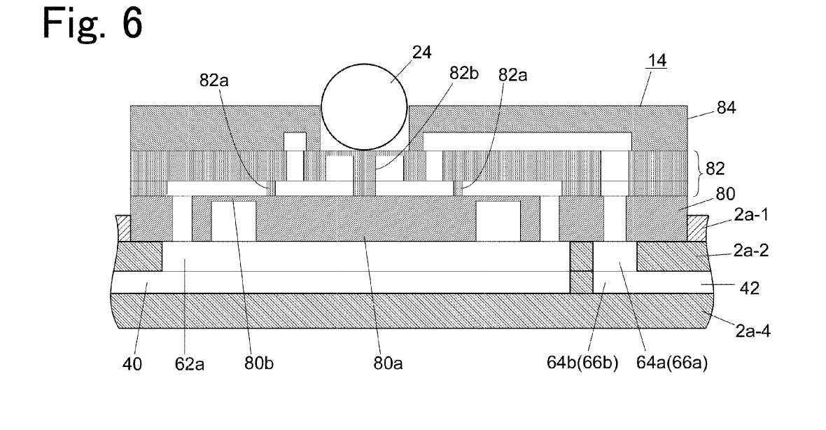

The valve element 14 that is mounted on the substrate 2a is shown in FIG. 6. The valve element 14 is formed from two layers of SOI (silicon-on-insulator) substrates 80 and 82, and a glass substrate 84. The SOI substrate includes a Box layer (buried oxide layer) inside a silicon substrate. The material of the glass substrate 84 is not particularly limited, but in this case, a TEMPAX (registered trademark) glass substrate is used as a glass substrate whose linear expansion coefficient is close to the linear expansion coefficient of silicon.

A valve seat (seat) 82a is formed by the SOI substrate 82, and a disc section 80a is formed by the SOI substrate 80. The disc section 80a is supported by a diaphragm 80b in a manner movable in the vertical direction, and the disc section 80a is capable of opening/closing with respect to the valve seat 82a. A pressing section 82b abuts against the upper central portion of the disc section 80a, and the upper portion of the pressing section 82b is to be pressed downward by the actuator 26 (see FIG. 4B) via the ball 24. The inlet-side channel 40 formed on the substrate 2a communicates with the underside of the disc section 80a and the outside of the valve seat 82a, and the outlet-side channel 42 communicates with the inside of the valve seat 82a.

With the exception of the area between the disc section 80a and the valve seat 82a, the SOI substrates 80 and 82 are bonded with gold, the SOI substrate 82 and the glass substrate 84 are anodic bonded, and the SOI substrate 80 and the insulating substrate layer 2a-2 are bonded with an adhesive.

When the pressing section 82b is pressed downward with the ball 24 by the actuator 26, the disc section 80a moves downward, and a gap to the valve seat 82a is created and the valve is opened, and gas flows from the inlet-side channel 40 to the outlet-side channel 42. When pressing by the actuator 26 is released, the disc section 80a moves upward by being pressed by the pressure of gas from the inlet-side channel 40 and the gap to the valve seat 82a is closed, and the flow of gas from the inlet-side channel 40 to the outlet-side channel 42 is stopped.

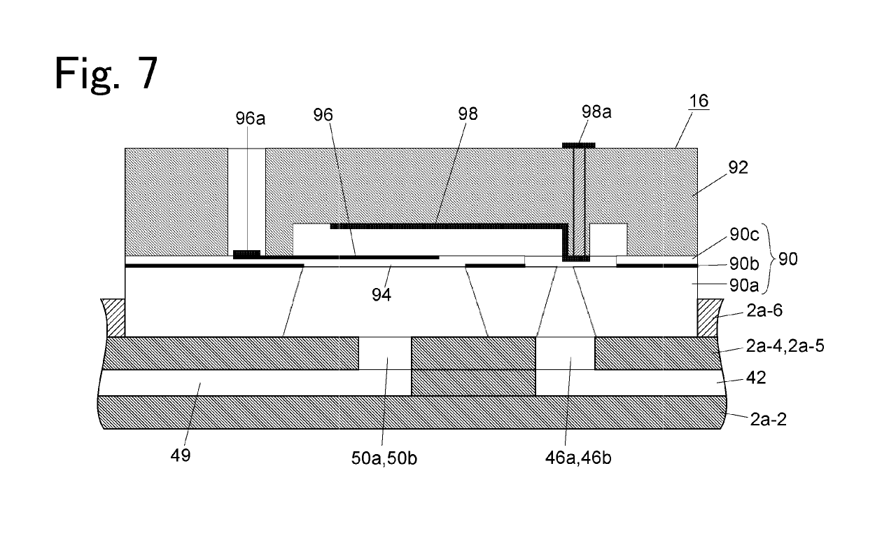

The pressure sensor element 16 mounted on the substrate 2a is shown in FIG. 7. This pressure sensor element 16 is of a capacitive type, and is formed from an SOI substrate 90 and a glass substrate 92. The material of the glass substrate 92 is not particularly limited, but also in this case, a TEMPAX (registered trademark) glass substrate whose linear expansion coefficient is close to the linear expansion coefficient of silicon is used as the glass substrate. The SOI substrate 90 has a Box layer 90b formed inside the silicon substrate, and has a three-layer structure of a silicon layer 90a, the Box layer 90b, and a silicon layer 90c.

A diaphragm 94 is formed by the silicon layer 90c above the Box layer 90b, and a lower electrode 96 is formed on the diaphragm 94, on the side of the glass substrate 92. A cavity is formed on the glass substrate 92, on the side facing the diaphragm 94, and an upper electrode 98 facing the lower electrode 96 is formed inside the cavity. To detect the capacitance between the upper electrode 98 and the lower electrode 96, an extraction electrode 98a of the upper electrode 98 and an extraction electrode 96a of the lower electrode 96 are provided. The upper side of the diaphragm 94, that is, the space between the upper electrode 98 and the lower electrode 96, communicates with the inner channel 42 inside the substrate 2a, and the space on the lower side of the diaphragm 94 communicates with the atmosphere-side communicating path 49.

The diaphragm 94 is deformed in the vertical direction in FIG. 7 due to a pressure difference between the pressure inside the inner channel 42 and the atmospheric pressure, and the gap between the electrodes 96 and 98 is changed accordingly, thereby changing the capacitance between the electrodes 96 and 98. The capacitance is converted into a voltage by the capacitance-to-digital converter, and is then converted into a pressure value.

In this embodiment, the metal layers 68a to 68c for blocking noise that are electrically connected to one another are provided. While the noise level is about 130 aFp-p when such metal layers are not provided, the noise level is reduced to about 90 aFp-p in this embodiment where the metal layers 68a to 68d are provided.

Now, a manufacturing method common to the embodiments will be described. A via metal is embedded or a metal layer of molybdenum or the like is print-coated as necessary on a semi-dry alumina ceramic substrate layer where a penetration hole and a groove are opened. Then, alumina ceramic substrate layers are made to overlap in a stacked state, sintered at about 1000 to 1500° C., and gold plating or the like is applied to necessary portions to obtain the substrate 2 or 2a. Then, a valve element and a pressure sensor element are fixed to predetermined positions of the sintered substrate by an adhesive, and a capacitance-to-digital converter and a connector are soldered as necessary, and wire bonding for necessary electrical connection is applied.

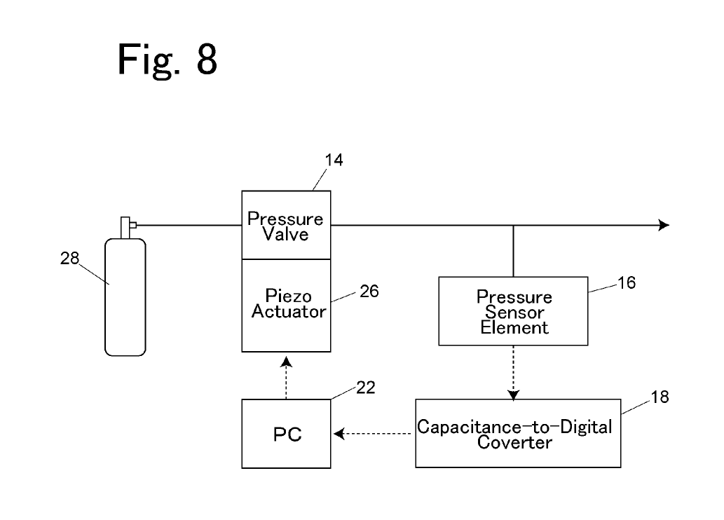

FIG. 8 schematically shows a control system for gas pressure control that is common to the embodiments. Capacitance which is the detection signal of the pressure sensor element 16 is converted into a voltage by the capacitance-to-digital converter 18, and is input to the computer of the control section 22. The computer 22 feedback-controls the opening of the pressure valve 14 via the actuator 26 so that the detection signal of the pressure sensor element 16 takes a predetermined value, and gas on the outlet-side of the pressure valve is thereby supplied at a predetermined constant pressure. The reference sign 28 is a gas supply section such as a gas cylinder. In FIG. 8, the solid line indicates the flow of gas, and the dashed line indicates the flow of the signal.

As shown in FIG. 1, the control section 22 includes the temperature correction section 23. The influence of a change in the environmental temperature is corrected by using the temperature measurement function included in the capacitance-to-digital converter. With respect to this temperature correction, temperature correction of an electronic part is processed by software in the following manner.

According to the catalog specifications, the capacitance-to-digital converter has a temperature characteristic of −1 af/° C. with respect to a reference temperature of 25° C. Also, the temperature characteristic of the capacitor is assumed to be −40 ppm/° C. at a reference temperature of 20° C. The amount of capacitance caused by the difference between the measurement temperature and the reference temperature is taken as the correction value.

The result of temperature correction performed in the above manner is shown in FIG. 9. A is the temperature variation width and is 2.689° C. In this case, with respect to the capacitance value, a variation width B is 1.627 pF before correction, but a variation width C is reduced to 0.301 pF by the correction.

### DESCRIPTION OF REFERENCE SIGNS

2: Substrate
2a: Insulating substrate
2-1 to 2-3, 2a-1 to 2a-6: Substrate layer
4: Gas inlet
6: Gas outlet
8-1, 8-2: Penetration groove as inner channel
8-2a: Penetration groove for channel resistor
14: Valve element
16: Pressure sensor element
18: Capacitance-to-digital converter
22: Control section
23: Temperature correction section
26: Actuator
30: Fixing base
45: Pressure sensor element mounting position
60: Valve element mounting position
68a, 68b, 68c, 68d: Metal layer
75: Capacitance-to-digital converter mounting position

1. A gas pressure controller comprising:
an insulating substrate having a gas inlet and a gas outlet, and including an inner channel, the insulating substrate being a stacked body formed from a plurality of insulating substrate layers;
a valve mechanism including an MEMS valve element that is attached directly on a front surface or a back surface of the insulating substrate and that is connected to the inner channel via a port communicating with the inner channel;
a pressure sensor section including an MEMS pressure sensor element that is attached directly to the front surface or the back surface of the insulating substrate and that is connected to the inner channel via a port communicating with the inner channel; and
a control section for feedback-controlling the valve mechanism based on a detection signal of the pressure sensor section,
wherein a metal layer for electrical connection is formed on at least one of the front surface, the back surface and an inner joining surface of the insulating substrate.

2. (canceled)

3. The gas pressure controller according to claim 1, wherein a metal layer for electromagnetic shielding, not contributing to electrical connection, is formed on at least one of the front surface, the back surface and an inner joining surface of the insulating substrate.

4. The gas pressure controller according to claim 1, wherein the insulating substrate is made of alumina ceramic.

5. The gas pressure controller according to claim 1, wherein the inner channel includes a channel resistor portion whose channel width is narrower than a channel communicating with the gas outlet.

6. (canceled)

7. (canceled)

8. (canceled)

9. The gas pressure controller according to claim 1,
wherein the MEMS pressure sensor element is a capacitive pressure sensor element, and
wherein the pressure sensor section includes a capacitance-to-digital converter for converting a detected capacitance of the capacitive pressure sensor element to a voltage output, the capacitance-to-digital converter being arranged near the capacitive pressure sensor element.

10. (canceled)

11. (canceled)

12. The gas pressure controller according to claim 9,
wherein the capacitance-to-digital converter includes a temperature measurement function, and
the gas pressure controller further comprising a temperature correction section is configured to correct a variation in a detection output of the MEMS pressure sensor element due to a temperature, based on a signal corresponding to a temperature measured by the temperature measurement function of the capacitance-to-digital converter.

13. (canceled)

14. The gas pressure controller according to claim 4,
wherein at least one of the MEMS valve element and the MEMS pressure sensor element is made of silicon.
